(19) United States
(12) Patent Application Publication
(10) Pub. No.: US 2010/0224036 A1
(43) Pub. Date: Sep. 9, 2010

(54) SELF ADJUSTING FLAT WRENCH

(76) Inventor: Najati Monem, Gretna, LA (US)

Correspondence Address: MARK TERRY, ESQ., 801 BRICKELL AVE., SUITE 900, Miami, FL, 33131, US

(21) Appl. No.: 12/398,038

(22) Filed: Mar. 4, 2009

(51) Int. Cl. B25B 13/16

(52) U.S. Cl. 81/165

(57) ABSTRACT

A self-adjusting flat wrench is disclosed. The self-adjusting flat wrench includes a fixed jaw for contacting a face of a fastener, a movable jaw opposite the fixed jaw and an adjusting screw for adjusting a position of the movable jaw in relation to the fixed jaw. The self-adjusting flat wrench further includes a sub-jaw for contacting a face of a fastener, the sub-jaw movably coupled to the movable jaw such that the sub-jaw may move downwards towards the self-adjusting flat wrench and upwards away from the self-adjusting flat wrench. The self-adjusting flat wrench further includes a spring for continuously pushing the sub-jaw downwards towards the self-adjusting flat wrench.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

This invention relates to adjustable wrenches and more particularly to adjustable flat wrenches in which the jaws are adjustable via rotation of a screw or other means.

### BACKGROUND OF THE INVENTION

Wrenches hold and turn threaded fasteners such as pipes, nuts, bolts, screws, and plugs, as well as other threaded parts and pipes. Different styles of wrenches are designed to meet the needs of the fastener, a part's location or the unique design of the fastener or part. Most wrenches are designed to loosen or tighten objects of only one diameter. Adjustable wrenches have a moveable jaw which will fit a range of diameters. A flat wrench is a wrench that does not have a socket that surrounds a part; it simply fits around one side of a pipe, nut or bolt, like a crescent wrench.

Adjustable flat wrenches, such as crescent wrenches, are well known in the art and comprise a pair of jaws which are opened and closed in response to rotation of an adjustment screw located in the wrench body and usually operable by a user's thumb. Rotation of the adjustment screw in one direction will cause opening of the wrench jaws while rotation of the adjustment screw in the other direction will cause closure of the wrench jaws. Although the movement of the jaws in response to a given adjustment screw rotation can be remembered or learned for each wrench position, usually a user will rotate the adjustment screw in one direction and reverse the direction of the jaws are not moving in the intended manner.

A problem with adjustable flat wrenches is that before use the jaws must be opened, usually by rotating an adjustment screw manually or using a motor mechanism, to a width greater than the width of a nut or bolt that is being tightened or loosened. After the adjustable flat wrench is placed around the pipe, nut or bolt, the jaws must then be tightened to the width of the pipe, nut or bolt so as to secure the jaws around the item. The user then rotates the wrench in one direction to tighten or loosen the pipe, nut or bolt. But because there are typically obstructions or other factors that restrict a user from rotating a wrench a full 360 degrees, the user must remove the wrench from the pipe, nut or bolt after a half or quarter turn and then re-position the wrench onto the item. This requires the jaws of the wrench to be repeatedly opened for removal from the pipe, nut or bolt and then closed over the item when the wrench is re-positioned. Turn after turn, the process of opening and closing the jaws of the wrench is repeated until the pipe, nut or bolt is tightened or loosened to its desired state. This can be a slow and tedious process for a workman. Further, the repetitive nature of the act can cause fatigue of a user's muscles.

Various approaches to this problem, with regard to flat wrenches, involve the use of a motor or other automatic mechanism for effectuating the opening and closing of the jaws of the flat wrench. These approaches allow for a mechanism to automatically open and close the jaws of the flat wrench so as to eliminate the need for the user to do the opening and closing manually. These approaches, however, only automate the process of opening and closing the jaws of the flat wrench and do not address the problem of having to remove the wrench from the pipe, nut or bolt every half or quarter turn and then re-positioning the wrench onto the item. Other approaches to this problem include the use of a socket-type mechanism that surrounds the head of a nut or bolt. Socket-type wrenches, however, are associated with a variety of problems not associated with flat wrenches, such as non-adjustability of sockets, availability of sockets in lesser-used sizes and obstruction situations that do not allow for the use of sockets.

Therefore, a need exists to overcome the problems with the prior art as discussed above, and particularly for a more efficient way for an adjustable flat wrench to fasten onto a moving part while rotating.

### SUMMARY OF THE INVENTION

Briefly, according to an embodiment of the present invention, a self-adjusting flat wrench is disclosed. The self-adjusting flat wrench includes a fixed jaw for contacting a face of a fastener, a movable jaw opposite the fixed jaw and an adjusting screw for adjusting a position of the movable jaw in relation to the fixed jaw. The self-adjusting flat wrench further includes a sub-jaw for contacting a face of a fastener, the sub-jaw movably coupled to the movable jaw such that the sub-jaw may move downwards towards the self-adjusting flat wrench and upwards away from the self-adjusting flat wrench. The self-adjusting flat wrench further includes a spring for continuously pushing the sub-jaw downwards towards the self-adjusting flat wrench.

In another embodiment of the present invention, a self-adjusting flat wrench is disclosed. The self-adjusting flat wrench includes a fixed jaw for contacting a face of a fastener, wherein the fixed jaw includes a first planar working face. The flat wrench further includes a movable jaw opposite the fixed jaw, wherein the movable jaw includes a second planar working face that slopes away from the first planar working face at an acute angle. The flat wrench further includes an adjusting screw for adjusting a position of the movable jaw in relation to the fixed jaw and a sub-jaw including a corrugated face for contacting a face of the fastener, the sub-jaw movably coupled to the movable jaw such that the sub-jaw may move downwards towards the self-adjusting flat wrench and upwards away from the self-adjusting flat wrench. The flat wrench further includes a spring for continuously pushing the sub-jaw downwards towards the self-adjusting flat wrench.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is an illustration of a frontal view of a self-adjusting flat wrench, according to one embodiment of the present invention.

FIG. 2 is an illustration of a perspective view of the self-adjusting flat wrench of FIG. 1.

FIG. 3 is an illustration of a frontal view of the self-adjusting flat wrench of FIG. 1, while in a first rotating position.

FIG. 4 is an illustration of a frontal view of the self-adjusting flat wrench of FIG. 1, while in a second rotating position.

FIG. 5 is an illustration of a frontal view of the self-adjusting flat wrench of FIG. 1, while in a third rotating position.

FIG. 6 is an illustration of a frontal view of the self-adjusting flat wrench of FIG. 1, while in a fourth rotating position.

FIG. 7 is an illustration of a perspective view of the self-adjusting flat wrench of FIG. 1, showing the self-adjusting flat wrench in a disassembled fashion.

FIG. 8 is an illustration of a frontal view of the self-adjusting flat wrench of FIG. 1, showing a cutout section displaying the placement of inner working parts.

FIG. 9 is an illustration of a perspective view of the movable sub-jaw of the self-adjusting flat wrench, according to one embodiment of the present invention.

FIG. 10 is an illustration of a frontal view of the movable sub-jaw of FIG. 9.

FIG. 11 is an illustration of a side view of the movable sub-jaw of FIG. 9.

FIG. 12 is an illustration of a top view of the movable sub-jaw of FIG. 9.

FIG. 13 is an illustration of a frontal view of another embodiment of a self-adjusting flat wrench, according to a second embodiment of the present invention.

FIG. 14 is an illustration of a frontal view of yet another embodiment of a self-adjusting flat wrench, according to one embodiment of the present invention.

### DETAILED DESCRIPTION

The present invention provides a self adjusting flat wrench that eliminates the need for opening a closing the jaws of an adjustable flat wrench when rotating a pipe, nut or bolt. The apparatus of the present invention includes the basic elements of an adjustable flat wrench, including a wrench body having a fixed jaw, an angularly disposed handle, and a movable jaw which is coupled to, and movable in response to rotation of, an adjustment screw. The apparatus of the present invention further includes a movable sub-jaw located on the flat working face of the movable jaw. The jaws of the adjustable flat wrench are closed securely onto the pipe, nut or bolt being tightened or loosened such that the flat working face of the movable sub-jaw contacts a first face of the pipe, nut or bolt. As the adjustable flat wrench is rotated in a direction that forces the movable sub-jaw downwards into the flat wrench, the pipe, nut or bolt is rotated along with the wrench. As the adjustable flat wrench is rotated in a direction that forces the movable sub-jaw upwards and away from the flat wrench, the pipe, nut or bolt is not rotated along with the wrench and the movable sub-jaw moves upwards and away from the flat wrench. As the adjustable flat wrench continues to be rotated in the same direction, the movable sub-jaw slides back to its original position via an inner spring and contacts the next face of the pipe, nut or bolt, thereby placing the adjustable flat wrench in a position to continue rotating in its original direction.

The features of the present invention are advantageous as they allow for the continual tightening or loosening of a pipe, nut or bolt without the need for periodically manually adjusting the jaws of the wrench. The present invention is self-adjusting and thereby eliminates the need for manually adjusting a wrench during turning or rotating of a pipe, nut or bolt.

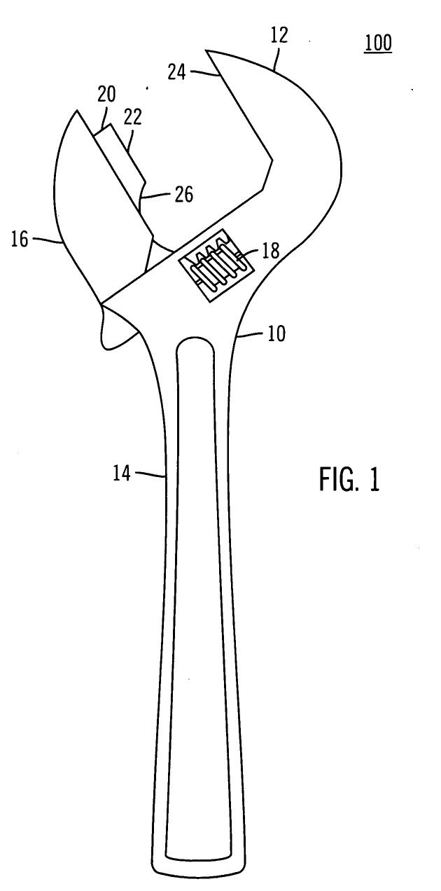

FIG. 1 is an illustration of a frontal view of a self-adjusting flat wrench 100, according to one embodiment of the present invention. FIG. 1 shows a self-adjusting flat wrench 100 of the type which is known as a crescent wrench and which includes a wrench body 10 having a fixed jaw 12, an angularly disposed handle 14, and a movable jaw 16 which is coupled to, and movable in response to rotation of, an adjustment screw 18. The fixed jaw 12 includes a flat working face 24 for placing against a pipe, nut or bolt. In the illustrated embodiment, rotation of screw 18 in the upwards direction will cause tightening or closure of jaws 12 and 16. Conversely, rotation of screw 18 in the downwards direction will cause loosening or opening of the jaws.

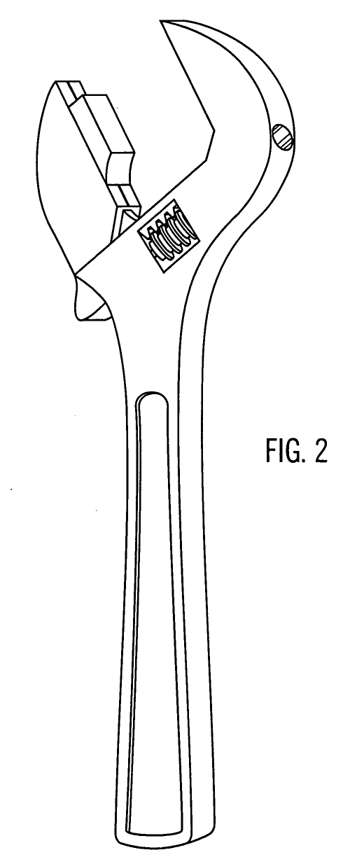

FIG. 1 also shows a movable sub-jaw 20 having a flat working face 22 that is parallel to the flat working face 24 of the fixed jaw 12. The movable sub-jaw 20 further includes a sloping face 26 below the flat working face 22, wherein the sloping face include a concave, or curved face. The movable sub-jaw 20 is fixed to the movable jaw 16 such that the movable sub-jaw 20 can move up and down parallel to the plane of the flat working face 22. Further details of the movement and function of the movable sub-jaw 20 are provided below. FIG. 2 is an illustration of a perspective view of the self-adjusting flat wrench 100 of FIG. 1.

The components of the self-adjusting flat wrench 100 can be manufactured from a variety of materials using a variety of methods. In one embodiment of the present invention, the components of the self-adjusting flat wrench 100, including the wrench body 10, the fixed jaw 12, the angularly disposed handle 14, the movable jaw 16 the adjustment screw 18 and the movable sub-jaw 20, can be manufactured from hot-forged alloy steel, ferrous metals, nickel, nickel alloys, etc. Additionally, the components of the self-adjusting flat wrench 100 may include nickel-chrome plating that resists rust.

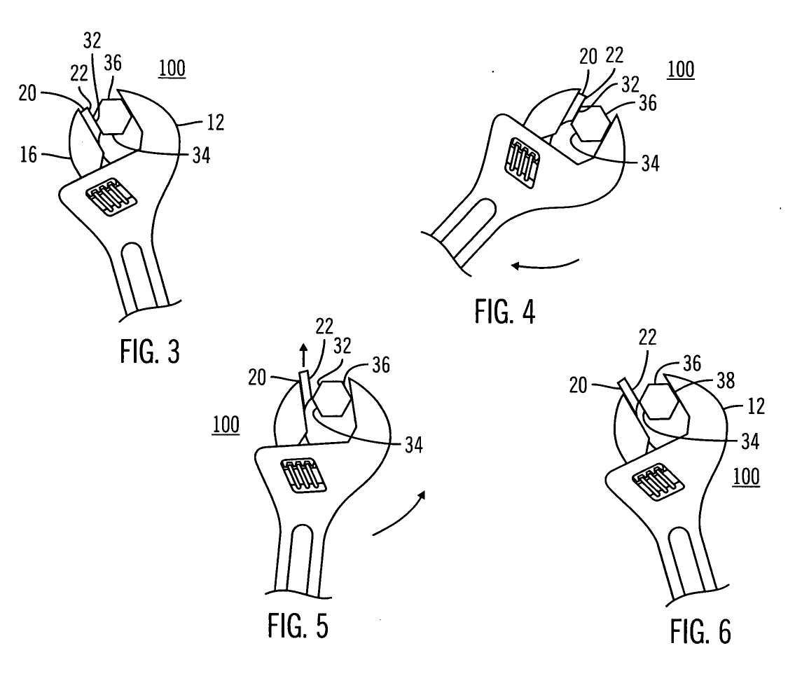

FIG. 3 is an illustration of a frontal view of the self-adjusting flat wrench 100 of FIG. 1, while in a first rotating position. The jaws 16, 12 of the adjustable flat wrench 100 are closed securely onto a hexagonal nut 36 that is being tightened. The flat working face 22 of the movable sub-jaw 20 contacts the face 32 of the hexagonal nut 36. The use of the self-adjusting flat wrench 100 of FIG. 3 then commences rotating the flat wrench 100 in the clockwise direction.

FIG. 4 is an illustration of a frontal view of the self-adjusting flat wrench 100 of FIG. 1, while in a second rotating position. As the adjustable flat wrench 100 is rotated in the clockwise direction, i.e., a direction that forces the movable sub-jaw 20 downwards into the flat wrench 100, the hexagonal nut 36 is rotated along with the wrench 100 as the flat working face 22 of the movable sub-jaw 20 continues to contact the face 32 of the hexagonal nut 36. At this point, the user can no longer continue to rotate the wrench 100 in a clockwise direction because of an obstruction or any other reason and must therefore turn the wrench in a counter clockwise direction so as to reposition the wrench 100 on the hexagonal nut 36.

FIG. 5 is an illustration of a frontal view of the self-adjusting flat wrench 100 of FIG. 1, while in a third rotating position. As the adjustable flat wrench 100 is rotated in the counter clockwise direction, i.e., a direction that forces the movable sub-jaw 20 upwards and away from the flat wrench 100, the hexagonal nut 36 is not rotated along with the wrench 100 as the flat working face 22 of the movable sub-jaw 20 is pulled off and loses contact with the face 32 of the hexagonal nut 36. FIG. 5 shows that the movable sub-jaw 20 moves upwards and away from the wrench 100 as the wrench 100 is rotated in the counter clockwise direction. Because the movable sub-jaw loses contact with the face 32 of the hexagonal nut 36, the hexagonal nut 36 is not rotated along with the wrench 100 as it rotates in the counter clockwise direction.

FIG. 6 is an illustration of a frontal view of the self-adjusting flat wrench 100 of FIG. 1, while in a final rotating position. FIG. 6 shows that the wrench 100 has been returned to its original position as shown in FIG. 3 as the flat working face of the fixed jaw 22 is positioned in contact with the face 38 of the hexagonal nut 36. The movable sub-jaw 20 continues to be positioned upwards from the wrench 100 as it was pulled in the direction in the step of FIG. 5. As the face 22 of the movable sub-jaw 20 is placed in parallel with the face 34 of the hexagonal nut 36, the movable sub-jaw is moved downwards towards the wrench 100 by a spring (not shown), as to be positioned in contact with the face 34, thereby being in a position similar to that of FIG. 3.

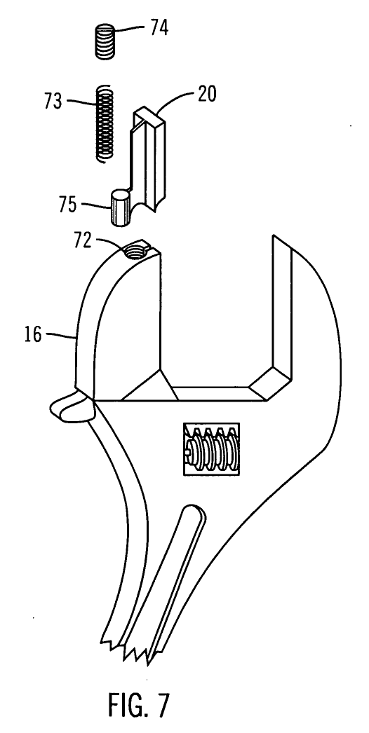

FIG. 7 is an illustration of a perspective view of the self-adjusting flat wrench 100 of FIG. 1, showing the self-adjusting flat wrench 100 in a disassembled fashion. FIG. 7 shows that the movable sub-jaw 20 being removed from the movable jaw 16. FIG. further shows that a cylindrical portion 75 of the movable sub-jaw 20 is placed within a straight tubular orifice 72 having a threaded inside surface. As the cylindrical portion 75 of the movable sub-jaw 20 is placed within the orifice 72, a spring 73 is also inserted into the orifice 72 on top of the cylindrical portion 75. Then, a threaded nut or bolt 74 is screwed into the threaded portion of the orifice 72 so as to compress the spring and keep the cylindrical portion 75 and the spring 73 in place within the orifice 72. This arrangement allows for the cylindrical portion 75 (and thus the movable sub-jaw 20) to move upwards and downwards within the orifice 72. The spring 73 applies constant pressure onto the cylindrical portion 75 placed within the orifice 72 such that when an external pressure moves the movable sub-jaw 20 upwards and then the external pressure ceases, the spring 73 pushes the cylindrical portion 75 (and thus the movable sub-jaw 20) downwards to its original position.

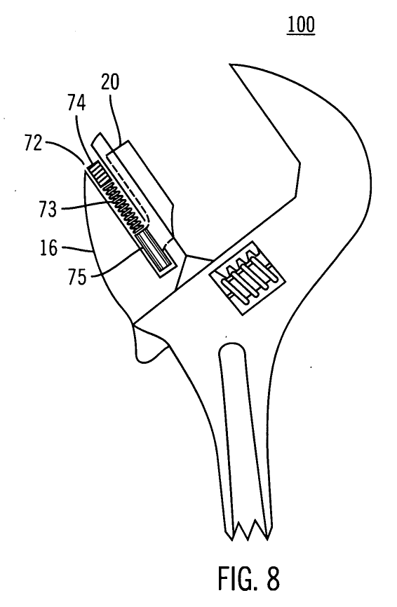

FIG. 8 is an illustration of a frontal view of the self-adjusting flat wrench 100 of FIG. 1, showing a cutout section displaying the placement of inner working parts. FIG. 8 shows that the cylindrical portion 75 of the movable sub-jaw 20 is placed within the straight tubular orifice 72. As the cylindrical portion 75 of the movable sub-jaw 20 is placed within the orifice 72, a spring 73 is inserted into the orifice 72 on top of the cylindrical portion 75. A threaded nut or bolt 74 is screwed into the threaded portion of the orifice 72 so as to compress the spring and keep the cylindrical portion 75 and the spring 73 in place within the orifice 72. This allows for the cylindrical portion 75 to move upwards and downwards within the orifice 72. The spring 73 applies constant pressure onto the cylindrical portion 75 placed within the orifice 72.

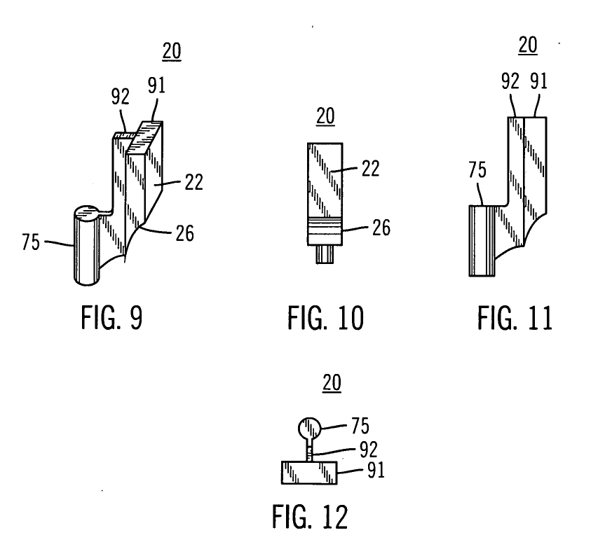

FIG. 9 is an illustration of a perspective view of the movable sub-jaw 20 of the self-adjusting flat wrench 100, according to one embodiment of the present invention. FIG. 9 shows the movable sub-jaw 20 having a first portion 91 having a roughly rectangular shape. The movable sub-jaw 20 includes a flat working face 22 and a sloping face 26 below the flat working face 22, wherein the sloping face include a concave, or curved face. Also shown is the cylindrical portion 75 of the movable sub-jaw 20, the cylindrical portion shaped in such a way to fit securely within the orifice 72 of the wrench 100. Finally, a thin section 92 is also shown, which is a this sheet-like section that connects the cylindrical portion 75 with the first portion 91 of the movable sub-jaw 20.

FIG. 10 is an illustration of a frontal view of the movable sub-jaw 20 of FIG. 9. FIG. 10 shows the flat working face 20 and the sloping face 26. FIG. 11 is an illustration of a side view of the movable sub-jaw 20 of FIG. 9. FIG. 11 shows the cylindrical portion 75, the thin portion 92 and the rectangular portion 91. FIG. 12 is an illustration of a top view of the movable sub-jaw 20 of FIG. 9. FIG. 12 also shows the cylindrical portion 75, the thin portion 92 and the rectangular portion 91.

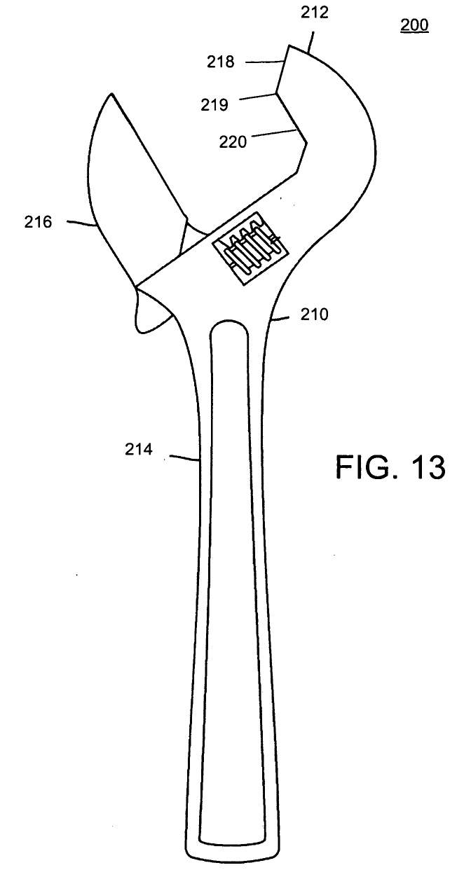

FIG. 13 is an illustration of a frontal view of a self-adjusting flat wrench 200, according to a second embodiment of the present invention. FIG. 13 shows a self-adjusting flat wrench 200 of the type which is known as a crescent wrench, similar to wrench 100. The self-adjusting flat wrench 200 includes a wrench body 210 having an angled fixed jaw 212, an angularly disposed handle 214, and a movable jaw 216 which is coupled to, and movable in response to rotation of, an adjustment screw. The fixed jaw 212 includes a flat working face 220 for placing against a nut or bolt. In the illustrated embodiment, rotation of the adjustment screw in the upwards direction will cause tightening or closure of jaw 216. Conversely, rotation of the screw in the downwards direction will cause loosening or opening of the jaw 216.

FIG. 13 also shows an angled face 218 located in the upper area of the jaw 212. The face 220 joins face 218 at the junction 219, which may have a point at the angled juncture (approximately 135 degrees) or may be a rounded juncture. Use of the wrench 200 is described below.

The jaws 216, 212 of the adjustable flat wrench 200 are closed securely onto a pipe, nut or bolt that is being tightened. The flat working face of the movable jaw 216 contacts the face of the pipe, nut or bolt. The user of the self-adjusting flat wrench 200 then commences rotating the flat wrench 200 in the clockwise direction. As the adjustable flat wrench 100 is rotated in the clockwise direction, the pipe, nut or bolt is rotated along with the wrench 200 as the flat working face of the movable jaw 216 continues to contact the face of the pipe, nut or bolt. At this point, the user can no longer continue to rotate the wrench 200 in a clockwise direction because of an obstruction or any other reason and must therefore turn the wrench in a counter clockwise direction so as to reposition the wrench 200 on the pipe, nut or bolt.

As the adjustable flat wrench 200 is rotated in the counter clockwise direction, the pipe, nut or bolt is not rotated along with the wrench 200 as the working face of the movable jaw 216 and the jaw 212 are pulled off and lose contact with the respective faces of the pipe, nut or bolt. The form of the surface 218 and the point 219 allow the jaw 212 to move upward and away from the surface of the pipe, nut or bolt as the wrench is rotated in the counter clockwise direction. Because the movable jaw 216 and the jaw 212 lose contact with the respective faces of the pipe, nut or bolt, the pipe, nut or bolt is not rotated along with the wrench 200 as it rotates in the counter clockwise direction. As the wrench 200 continues to turn counterclockwise, the flat working faces of the jaws 212, 216 are positioned in contact with the respective faces of the pipe, nut or bolt. Thus, this prepares the wrench 200 to be turned in the clockwise position once more to tighten the pipe, nut or bolt.

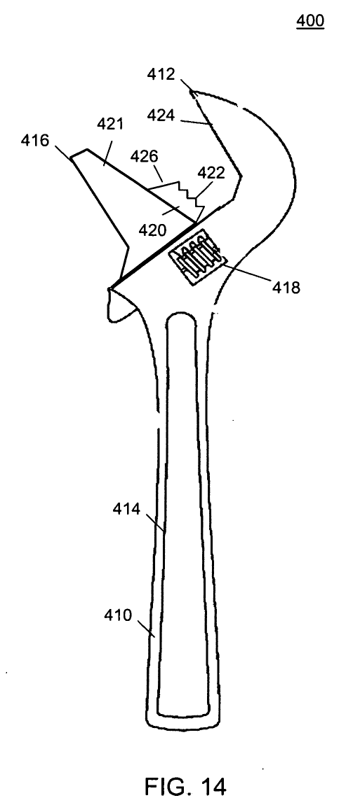

FIG. 14 is an illustration of a frontal view of another embodiment of a self-adjusting flat wrench 400, according to one embodiment of the present invention. FIG. 14 shows a self-adjusting flat wrench 400, similar to wrench 100, of the type which is known as a crescent wrench and which includes a wrench body 410 having a fixed jaw 412, an angularly disposed handle 414, and a movable jaw 416 which is coupled to, and movable in response to rotation of, an adjustment screw 418. The fixed jaw 412 includes a flat working face 424 for placing against a nut or bolt. In the illustrated embodiment, rotation of screw 418 in the upwards direction will cause tightening or closure of jaws 412 and 416. Conversely, rotation of screw 418 in the downwards direction will cause loosening or opening of the jaws.

FIG. 14 also shows a movable sub-jaw 420 having a working face 421 being roughly parallel to, but slightly sloping away (at an acute angle) from, the flat working face 424 of the fixed jaw 412. The movable sub-jaw 420 includes a corrugated working face 422 being substantially parallel to the face 424 and further includes a sloping face 426 above the corrugated working face 422, wherein the sloping face includes a flat face slanting at an angle making an obtuse angle with the face 421 of the movable jaw 416. The movable sub-jaw 420 is fixed to the movable jaw 416 such that the movable sub-jaw 420 can move up and down parallel to the plane of the working face 421. The movable sub-jaw 420 operates similarly to the sub-jaw 420 of FIG. 1. In one embodiment of the present invention, the flat working face 424 includes a corrugated surface so as to gain better purchase on the pipe, nut or bolt being rotated by the wrench 400, similar to the corrugated surface 422 of the movable sub-jaw 420.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A self-adjusting flat wrench, comprising:
a fixed jaw for contacting a face of a fastener;
a movable jaw opposite the fixed jaw;
an adjusting screw for adjusting a position of the movable jaw in relation to the fixed jaw;
a sub-jaw for contacting a face of the fastener, the sub-jaw movably coupled to the movable jaw such that the sub-jaw may move downwards towards the self-adjusting flat wrench and upwards away from the self-adjusting flat wrench; and
a spring for continuously pushing the sub-jaw downwards towards the self-adjusting flat wrench.

2. The self-adjusting flat wrench of claim 1, wherein in a rest position the sub-jaw is located at a maximum extent of a downwards direction.

3. The self-adjusting flat wrench of claim 2, wherein when the fixed jaw and the sub-jaw contact faces of the fastener and the self-adjusting flat wrench is rotated in a direction that forces the sub-jaw downwards into the self-adjusting flat wrench, the fastener is rotated along with the self-adjusting flat wrench.

4. The self-adjusting flat wrench of claim 3, wherein when the fixed jaw and the sub-jaw contact faces of the fastener and the self-adjusting flat wrench is rotated in a direction that forces the sub-jaw upwards away from the self-adjusting flat wrench, the fastener is not rotated along with the self-adjusting flat wrench.

5. The self-adjusting flat wrench of claim 4, wherein when the fixed jaw and the sub-jaw contact faces of the fastener and the self-adjusting flat wrench is rotated in a direction that forces the sub-jaw upwards away from the self-adjusting flat wrench, the sub-jaw moves away from the self-adjusting flat wrench and loses contact with the face of the fastener.

6. The self-adjusting flat wrench of claim 5, wherein if the self-adjusting flat wrench continues to be rotated in a direction that forces the sub-jaw upwards away from the self-adjusting flat wrench, the sub-jaw moves away from the self-adjusting flat wrench and loses contact with the face of the fastener, the sub-jaw then moves downwards due to the spring and contacts an adjacent face of the fastener.

7. The self-adjusting flat wrench of claim 3, wherein when the fixed jaw and the sub-jaw contact faces of the fastener and the self-adjusting flat wrench is rotated in a direction that forces the sub-jaw upwards away from the self-adjusting flat wrench, the sub-jaw moves away from the self-adjusting flat wrench and loses contact with the face of the fastener.

8. The self-adjusting flat wrench of claim 7, wherein if the self-adjusting flat wrench continues to be rotated in a direction that forces the sub-jaw upwards away from the self-adjusting flat wrench, the sub-jaw moves away from the self-adjusting flat wrench and loses contact with the face of the fastener, the sub-jaw then moves downwards due to the spring and contacts an adjacent face of the fastener.

9. The self-adjusting flat wrench of claim 2, wherein when the fixed jaw and the sub-jaw contact faces of the fastener and the self-adjusting flat wrench is rotated in a direction that forces the sub-jaw upwards away from the self-adjusting flat wrench, the fastener is not rotated along with the self-adjusting flat wrench.

10. The self-adjusting flat wrench of claim 7, wherein when the fixed jaw and the sub-jaw contact faces of the fastener and the self-adjusting flat wrench is rotated in a direction that forces the sub-jaw upwards away from the self-adjusting flat wrench, the sub-jaw moves away from the self-adjusting flat wrench and loses contact with the face of the fastener.

11. A self-adjusting flat wrench, comprising:
a fixed jaw for contacting a face of a fastener, wherein the fixed jaw includes a first planar working face;
a movable jaw opposite the fixed jaw, wherein the movable jaw includes a second planar working face that slopes away from the first planar working face at an acute angle;
an adjusting screw for adjusting a position of the movable jaw in relation to the fixed jaw;
a sub-jaw including a corrugated face for contacting a face of the fastener, the sub-jaw movably coupled to the movable jaw such that the sub-jaw may move downwards towards the self-adjusting flat wrench and upwards away from the self-adjusting flat wrench; and
a spring for continuously pushing the sub-jaw downwards towards the self-adjusting flat wrench.

12. The self-adjusting flat wrench of claim 11, wherein in a rest position the sub-jaw is located at a maximum extent of a downwards direction.

13. The self-adjusting flat wrench of claim 12, wherein when the fixed jaw and the sub-jaw contact faces of the fastener and the self-adjusting flat wrench is rotated in a direction that forces the sub-jaw downwards into the self-adjusting flat wrench, the fastener is rotated along with the self-adjusting flat wrench.

14. The self-adjusting flat wrench of claim 13, wherein when the fixed jaw and the sub-jaw contact faces of the fastener and the self-adjusting flat wrench is rotated in a direction that forces the sub-jaw upwards away from the self-adjusting flat wrench, the fastener is not rotated along with the self-adjusting flat wrench.

15. The self-adjusting flat wrench of claim 14, wherein when the fixed jaw and the sub-jaw contact faces of the fastener and the self-adjusting flat wrench is rotated in a direction that forces the sub-jaw upwards away from the self-adjusting flat wrench, the sub-jaw moves away from the self-adjusting flat wrench and loses contact with the face of the fastener.

16. The self-adjusting flat wrench of claim 15, wherein if the self-adjusting flat wrench continues to be rotated in a direction that forces the sub-jaw upwards away from the self-adjusting flat wrench, the sub-jaw moves away from the self-adjusting flat wrench and loses contact with the face of the fastener, the sub-jaw then moves downwards due to the spring and contacts an adjacent face of the fastener.
